(19) United States
(12) Patent Application Publication
(10) Pub. No.: US 2019/0329781 A1
(43) Pub. Date: Oct. 31, 2019

(54) DRIVING ASSIST SYSTEM AND DRIVING ASSIST METHOD

(71) Applicant: ISUZU MOTORS LIMITED, Shinagawa-ku, Tokyo (JP)

(72) Inventors: Kouki NATSUMI, Isehara-shi, Kanagawa (JP); Masaichi TAKAHASHI, Yokohama-shi, Kanagawa (JP); Shinichi ISHIGURO, Kawasaki-shi, Kanagawa (JP)

(21) Appl. No.: 16/349,924

(22) PCT Filed: Nov. 7, 2017
(86) PCT No.: PCT/JP2017/040073

§ 371 Date: May 14, 2019

(30) Foreign Application Priority Data
Nov. 14, 2016 (JP) 2016-221684

(51) Int. Cl. B60W 30/18; G08G 1/16; B60W 30/095

(52) U.S. Cl. CPC B60W 30/18163; G08G 1/167; B60W 2550/308; B60W 2550/302; B60W 30/0956

(57) ABSTRACT

A driving assist system equipped with an own vehicle speed sensor, an adjacent vehicle speed sensor, an instruction device, and a control device. When an own vehicle is traveling in a passing lane and an adjacent vehicle is traveling in a cruising lane, the control device controls in a manner such that the instruction device outputs an instruction to select the passing lane as the traffic lane in which the own vehicle should travel when the relative speed of the adjacent vehicle compared to the own vehicle is negative.

### TECHNICAL FIELD

The present disclosure relates to a driving assist system and a driving assist method, and more specifically to a driving assist system and a driving assist method for improving fuel efficiency.

### BACKGROUND ART

There has been proposed a device that determines a lane, in which a vehicle having a speed closer to a preset vehicle speed of a speed of a preceding vehicle traveling in a travel lane ahead of an own vehicle and a speed of an adjacent vehicle traveling ahead of the own vehicle in an adjacent lane to the travel lane is traveling, as a recommended travel lane (See, for example, Patent Literature 1.). This device saves a driver from judging a lane by causing the own vehicle to follow either the preceding vehicle or the adjacent vehicle.

### CITATION LIST

### Patent Document

Patent Literature 1: JP-A-2016-88504

### SUMMARY OF THE INVENTION

### Technical Problem

When the own vehicle travels at a preset target speed, the own vehicle may be on a highway and the like. A highway or the like has two or more lanes on one side including a travel lane and an overtaking lane for overtaking a preceding vehicle traveling in the travel lane.

When the above device is used on a highway or the like without taking the travel lane and the overtaking lane into consideration, unnecessary acceleration and deceleration occur and fuel efficiency may deteriorate accordingly.

An object of the present disclosure is to provide a driving assist system and a driving assist method that can improve fuel efficiency by reducing potential for causing unnecessary acceleration and deceleration when traveling on a road having two or more lanes on one side.

### Solution to Problem

The driving assist system of the present disclosure is mounted on an own vehicle and assists a lane change the own vehicle when the own vehicle travels on a road having two or more lanes including a travel lane and an overtaking lane on one side. The driving assist system includes: a relative speed acquisition device that acquires a relative speed of an adjacent vehicle relative to the own vehicle, the adjacent vehicle being traveling ahead in a same direction as the own vehicle in a lane adjacent to a lane in which the own vehicle is traveling; an instruction device that instructs a lane in which the own vehicle should travel; and a control device connected with the relative speed acquisition device and the instruction device. In a case where the own vehicle travels in the overtaking lane and the adjacent vehicle travels in the travel lane respectively, the control device controls the instruction device to issue an instruction to select the overtaking lane as a lane in which the own vehicle should travel when the relative speed acquired by the relative speed acquisition device is negative.

The driving assist method of the present disclosure assists a lane change of an own vehicle when the own vehicle travels in an overtaking lane and an adjacent vehicle travels ahead in a travel lane in a same direction as the own vehicle respectively on a road having two or more lanes including the travel lane and the overtaking lane on one side. A control device of the own vehicle acquires a relative speed of the adjacent vehicle relative to the own vehicle, determines whether or not the acquired relative speed is negative, and controls an instruction device to issue an instruction to select the overtaking lane as a lane in which the own vehicle should travel when it is determined that the relative speed is negative.

### Advantageous Effects of the Invention

According to the driving assist system and the driving assist method of the present disclosure, when the relative speed of the adjacent vehicle relative to the own vehicle is negative, that is, when a speed of the adjacent vehicle is lower than a speed of the own vehicle, it is possible for the own vehicle to travel in the overtaking lane and overtake the adjacent vehicle by issuing an instruction to select the overtaking lane as the lane in which the own vehicle should travel. Accordingly, when the speed of the adjacent vehicle is lower than the speed of the own vehicle, it is possible to reduce potential for causing unnecessary deceleration or re-acceleration of the own vehicle, which occurs when the given vehicle changes its lane into the travel lane, so that unnecessary fuel consumption can be reduced. Accordingly, fuel efficiency can be improved.

### BRIEF DESCRIPTION OF THE DRAWINGS

FIG. 1 is a plan view illustrating a state in which an own vehicle equipped with an embodiment of a driving assist system of the present disclosure will travel in an overtaking lane.

FIG. 2 is a plan view illustrating a state in which the own vehicle equipped with the embodiment of the driving assist system of the present disclosure will travel in a travel lane.

FIG. 3 is a flow diagram showing a driving assist method of the present disclosure.

### DESCRIPTION OF EMBODIMENTS

An embodiment of the present disclosure will be described with reference to drawings. In the drawings, x represents a travel direction (front-rear direction) of a vehicle and y represents a lateral direction (left-right direction) of the vehicle.

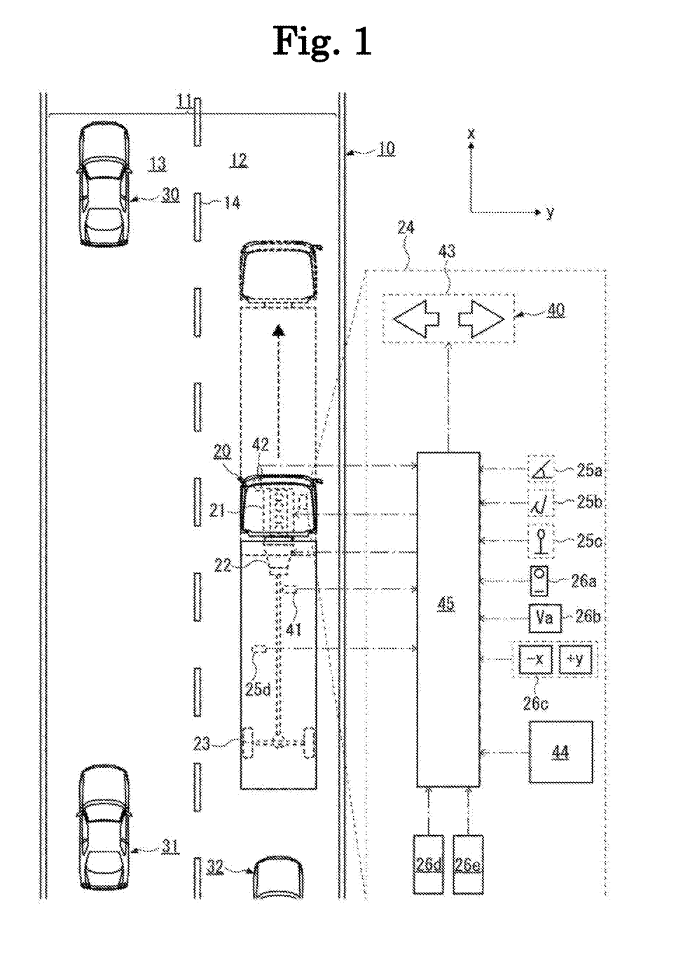

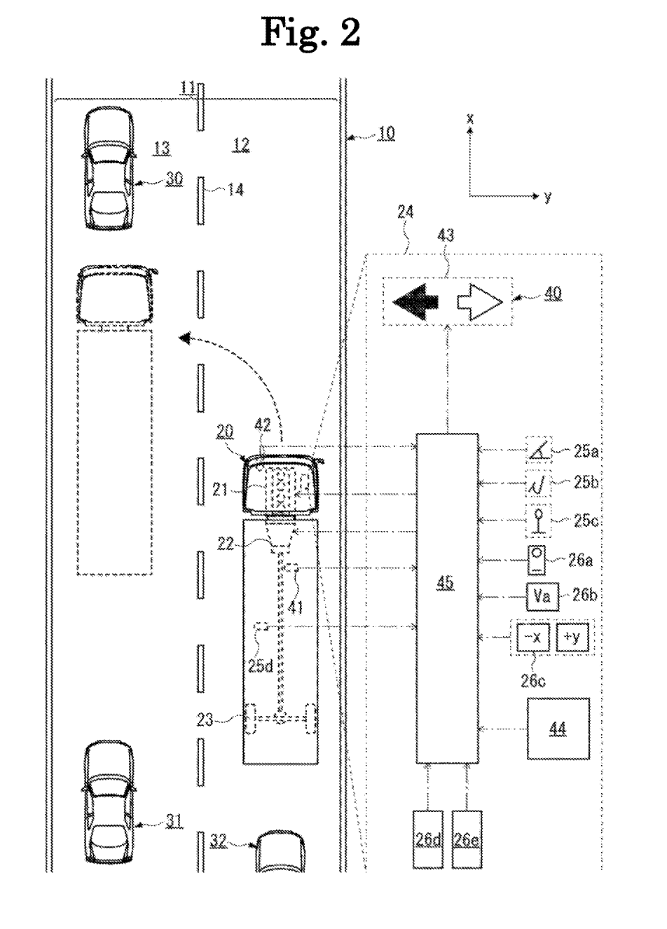

As illustrated in FIGS. 1 and 2, a driving assist system 40 according to the embodiment assists driving of an own vehicle 20 when the own vehicle 20 travels at a speed V2 in an overtaking lane 12 and an adjacent vehicle 30 travels at a speed V3 in a travel lane 13 on one side 11 of a road 10 respectively. The driving assist system 40 includes an own vehicle speed sensor 41, an adjacent vehicle speed sensor 42, an instruction device 43, and a control device 45.

The road 10 is a highway for a left side travelling and has two lanes including the overtaking lane 12 and the travel lane 13 on the one side 11. The overtaking lane 12 is adjacent to a center side of the road 10, that is, to a right side of the travel lane 13, and is available when overtaking a preceding vehicle traveling in the travel lane 13. In the case where the road 10 is for right side travelling, the overtaking lane 12 is adjacent to the center side of the road 10, that is, to a left side of the travel lane 13.

The own vehicle 20 includes an engine 21, a power transmission device 22, a drive wheel 23, and a control system 24. In the own vehicle 20, rotary power generated by the engine 21 is transmitted to the drive wheel 23 via the power transmission device 22 such as a clutch, a transmission, a propeller shaft, and a differential gear.

The control system 24, which includes the control device 45, various sensors (25a to 25d, 41, 42), and various devices (26a to 26e), is electrically connected to the engine 21 and the power transmission device 22 via signal lines indicated by chain lines.

The control device 45 is hardware formed by a CPU that performs various types of information processing, an internal storage device capable of reading and writing programs for information processing as well as information processing results, various interfaces, and the like. The control device 45 controls the engine 21 and the power transmission device 22 based on values acquired from various sensors and preset values in various devices.

Various sensors include, in a driving section, the accelerator opening sensor 25a that detects an accelerator opening degree from a press-down amount of an accelerator pedal, the brake opening sensor 25b that detects a brake opening degree as a press-down amount of a brake pedal, and the position sensor 25c that detects a position of a shift lever. The own vehicle speed sensor 41 that detects a vehicle speed of the own vehicle 20 and the acceleration sensor 25d are disposed on a chassis.

Various devices include, in the driving section, the operation switch 26a of an auto cruise mode, the speed setting switch 26b, the range setting switch 26c, the map information acquisition device 26d, and the vehicle weight acquisition device 26e.

The auto cruise mode (constant-speed traveling), which is started when the operation switch 26a is turned on, is particularly used when traveling on a highway, in which the own vehicle 20 is automatically driven to operate as scheduled by a program stored in the control system 24.

In the auto cruise mode, the control device 45 adjusts operation of the engine 21 and the power transmission device 22 to maintain the speed V2 of the own vehicle 20 at a target speed Va based on map information acquired by the map information acquisition device 26d and a vehicle weight estimated by the vehicle weight acquisition device 26e. Specifically, with the operation of the engine 21 and the power transmission device 22, the own vehicle 20 is automatically driven while maintaining the speed V2 at a constant speed range (Vb to Vc) from a lower limit value Vb (Va−x) to an upper limit value Vc (Va+y) that is set based on the target speed Va.

The constant speed range includes the lower limit value Vb and the upper limit value Vc set by the range setting switch 26c based on the target speed Va set by the speed setting switch 26b. The target speed Va, the lower limit Vb, and the upper limit Vc can be set to any value by a driver. For example, the target speed Va is 70 km/h or more and 90 km/h or less, the lower limit value Vb is −10 km/h or more and 0 km/h or less relative to the target speed Va, and the upper limit value Vc is 0 km/h or more and +10 km/h or less relative to the target speed Va.

An example of the map information acquisition device 26d can include a device using the satellite positioning system (GPS), which acquires a current position of the own vehicle 20 and three-dimensional road data containing a gradient and a travel distance of the road ahead on which the own vehicle 20 travels. Another example of the map information acquisition device 26d can include a device that acquires a gradient and a travel distance of the travel road from three-dimensional road data stored in a drive recorder. Further, a gradient may be calculated based on values acquired by the vehicle speed sensor 41 and the acceleration sensor (G sensor) 25e.

An example of the vehicle weight acquisition device 26e can include a device that estimates a vehicle weight of the own vehicle 20 using a motion equation of the own vehicle 20 in a front-rear direction based on parameters (speed and acceleration) that change during travel of the own vehicle 20. The vehicle weight acquisition device 26e may also use a system based on changes in an upper-lower direction when the own vehicle 20 is equipped with an air suspension, or a system based on torque input to a transmission before and after shift and an amount of change in a rotational speed output from the transmission. Further, a body weight according to changes in a load capacity may be acquired by a weight sensor such as a load cell.

The adjacent vehicle 30 is traveling in the travel lane 13 adjacent to the overtaking lane 12 in which the own vehicle 20 is traveling, and is ahead of the own vehicle 20 in the same direction. Here, “ahead” means a state in which a rear end of the adjacent vehicle 30 is forward of a front end of the own vehicle 20. That is, a vehicle on the y side of the vehicle 20 is not included in the adjacent vehicle 30. An adjacent succeeding vehicle 31 succeeds the adjacent vehicle 30 in the travel lane 13; more specifically, the adjacent succeeding vehicle 31 is overtaken by the own vehicle 20 or travels in parallel therewith. A succeeding vehicle 32 succeeds the own vehicle 20 and is traveling in the overtaking lane 12.

In this embodiment, a relative speed acquisition device acquires a relative speed ΔV1 of the adjacent vehicle 30 relative to the own vehicle 20, which uses two sensors including the own vehicle speed sensor 41 and the adjacent vehicle speed sensor 42. That is, the relative speed ΔV1 is obtained by subtracting the speed V2 acquired by the own vehicle speed sensor 41 from the speed V3 acquired by the adjacent vehicle speed sensor 42.

When the relative speed ΔV1 is negative, the speed V3 is lower than the speed V2 and the adjacent vehicle 30 is approaching the own vehicle 20. When the relative speed ΔV1 is positive, the speed V3 is higher than the speed V2 and the adjacent vehicle 30 is getting away from the own vehicle 20. When the relative speed ΔV1 is zero, the adjacent vehicle 30 is neither approaching nor getting away from the own vehicle 20 (a distance between them is substantially not changed).

The vehicle speed sensor 41 reads a pulse signal proportional to a rotational speed of a propeller shaft, and acquires the speed V2 of the own vehicle 20 for each sampling period by a vehicle speed calculation processing (not illustrated) of the control system 24. An example of the device that acquires the speed V2 of the own vehicle 20 may include, instead of the vehicle speed sensor 41, a sensor that acquires the speed V2 from a rotational speed of an output shaft, a drive wheel, a driven wheel, and the like (not illustrated) of the transmission.

The adjacent vehicle speed sensor 42 is a radar sensor that detects a position and the speed V3 of the adjacent vehicle 30 by radiating radio waves and receiving radio waves reflected by the adjacent vehicle 30. An example of the device that acquires the speed V3 of the adjacent vehicle 30 may include, instead of the adjacent vehicle speed sensor 42, a sensor that acquires the speed V3 by accessing a control system of the adjacent vehicle 30 by wireless communication.

The relative speed acquisition device may include only the adjacent vehicle speed sensor 42 when the adjacent vehicle speed sensor 42, which is a radar sensor, can directly acquire the relative speed ΔV1. The relative speed acquisition device may also acquire the relative speed ΔV1 by analyzing a video captured by an imaging device with an analysis device.

The instruction device 43 is an indicator disposed in a meter panel of the driving section. The instruction device 43 includes a pair of left and right arrows. The instruction device 43 issues to a driver an instruction to change a lane by turning on or off any one of the left and right arrows and issues to the driver an instruction to maintain a lane by turning off both the left and right arrows.

The lane acquisition device 44, which is an imaging device directed forward of the own vehicle 20, acquires a lane in which the own vehicle 20 is traveling by recognizing an image of a white line 14 laid on the road 10. An example of the lane acquisition device 44 can include a lane deviation warning device and the like. The lane acquisition device 44 may be used place of the map information acquisition device 26d.

The control device 45 controls the instruction device 43, when the own vehicle 20 is traveling in the overtaking lane 12 at a constant speed under the auto cruise mode, to indicate a lane in which the own vehicle 20 should travel based on the relative speed ΔV1.

Specifically, when the own vehicle 20 is traveling in the overtaking lane 12 and the adjacent vehicle 30 is traveling in the travel lane 13 respectively, the control device 45 controls the instruction device 43 to issue an instruction to select the overtaking lane 12 as the lane in which the own vehicle 20 should travel when the relative speed ΔV1 is negative. On the other hand, when the relative speed ΔV1 is zero or positive, the control device 45 controls the instruction device 43 to issue an instruction to select the travel lane 13 as the lane in which the own vehicle 20 should travel.

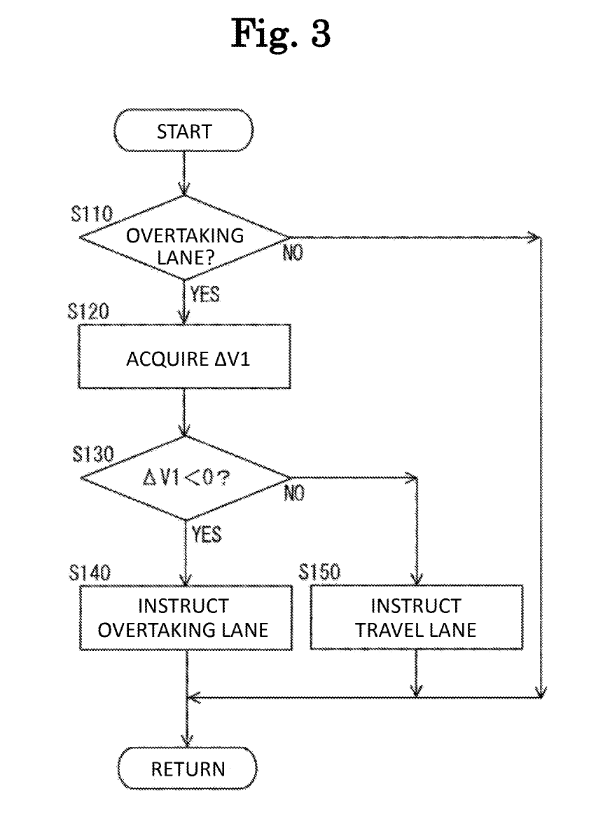

Next, a driving assist method of the present disclosure will be described as a function of the control device 45 with reference to a flowchart in FIG. 3. The following driving assist method starts when the operation switch 26a is turned on by the driver and the own vehicle 20 travels under the auto cruise mode, and is repeatedly performed at predetermined intervals. Then, the method ends when the auto cruise mode is ended.

First, the control device 45 determines whether or not the own vehicle 20 is traveling in the overtaking lane 12 by the lane acquisition device 44 (S110). When it is determined that the own vehicle 20 is traveling in the overtaking lane 12, the control device 45 acquires the relative speed ΔV1 by the own vehicle speed sensor 41 and the adjacent vehicle speed sensor 42 (S120).

Next, the control device 45 determines whether the relative speed ΔV1 is negative (S130). When the relative speed ΔV1 is negative, the speed V3 of the adjacent vehicle 30 is lower than the speed V2 of the own vehicle 20 and an inter-vehicle distance between the adjacent vehicle 30 and the own vehicle 20 gradually decreases. On the other hand, when the relative speed ΔV1 is zero, the speed V3 is the same as the speed V2 and the inter-vehicle distance between the adjacent vehicle 30 and the own vehicle 20 neither increases nor decreases. When the relative speed ΔV1 is positive, the speed V3 is higher than the speed V2 and the inter-vehicle distance between the adjacent vehicle 30 and the own vehicle 20 gradually increases.

That is, the determination that whether the relative speed ΔV1 is negative or not may be determination that whether the speed V3 of the adjacent vehicle 30 is lower than the speed V2 of the own vehicle 20.

Next, when it is determined that the relative speed ΔV1 is negative, the control device 45 controls the instruction device 43 to issue to the driver an instruction to select the overtaking lane 12 as the lane in which the own vehicle 20 should travel (S140). Specifically, under the control of the control device 45, the indicator of the instruction device 43 is turned off, and an instruction is issued to encourage the driver to maintain the overtaking lane 12 without changing the lane.

On the other hand, when it is determined that the relative speed ΔV1 is zero or positive, the control device 45 controls the instruction device 43 to issue to the driver an instruction to select the travel lane 13 as the lane in which the own vehicle 20 should travel (S150). Specifically, under the control of the control device 45, a leftward arrow in the indicator of the instruction device 43 is turned on, and an instruction is issued to encourage the driver to change a lane from the overtaking lane 12 to the travel lane 13.

As described above, when the own vehicle 20 is traveling in the overtaking lane 12 and the adjacent vehicle 30 is traveling in the travel lane 13 respectively and the relative speed ΔV1 of the adjacent vehicle 30 relative to the own vehicle 20 is negative, an instruction is issued to select the overtaking lane 12 as the lane in which the own vehicle 20 should travel.

Therefore, by issuing an instruction to select the overtaking lane 12 when the speed V3 of the adjacent vehicle 30 is lower than the speed V2 of the own vehicle 20, it is possible to cause the own vehicle 20 to travel in the overtaking lane 12 and overtake the adjacent vehicle 30.

Accordingly, when the speed V3 of the adjacent vehicle 30 is lower than the speed V2 of the own vehicle 20, it is possible to reduce potential for causing unnecessary deceleration or re-acceleration of the own vehicle 20, which occurs when the own vehicle 20 changes its lane into the travel lane 13, so that unnecessary fuel consumption can be reduced. Accordingly, fuel efficiency can be improved.

When the own vehicle 20 is traveling in the overtaking lane 12 under the auto cruise mode and the driving assist method is performed, it is possible to avoid hindering fuel saving control under the auto cruise mode. That is, fuel efficiency can be improved since a possibility of unnecessary deceleration or re-acceleration by the driver is reduced.

Particularly, the driving assist method described above is suitable in situations illustrated in FIGS. 1 and 2. In FIGS. 1 and 2, the succeeding vehicle 32, the own vehicle 20, the adjacent vehicle 30, and the adjacent succeeding vehicle 31 are arranged in descending order of speed, and the succeeding vehicle 32 is the fastest. FIGS. 1 and 2 illustrate a situation after the own vehicle 20 changes its lane from the travel lane 13 to the overtaking lane 12 and overtakes the adjacent succeeding vehicle 31 since a speed V4 of the adjacent succeeding vehicle 31 is low.

For example, as illustrated in FIG. 1, when the speed V3 of the adjacent vehicle 30 is lower than the speed V2 of the own vehicle 20 and the own vehicle 20 changes its lane into the travel lane 13, a speed V5 of the succeeding vehicle 32 is higher than the V2 of the own vehicle 20 and the succeeding vehicle 32 have to succeeds the adjacent vehicle 30 until overtaking the adjacent vehicle 30. Therefore, unnecessary deceleration occurs after the lane change. On the other hand, according to the driving assist system 40, when the speed V3 of the adjacent vehicle 30 is lower than the speed V2 of the own vehicle 20, it is possible for the own vehicle 20 to travel in the overtaking lane 12 and overtake the adjacent vehicle 30 by issuing an instruction to select the overtaking lane 12 as the lane in which the own vehicle 20 should travel via the instruction device 43. After the own vehicle 20 overtakes the adjacent vehicle 30, the same control as described above is performed based on a relative speed of a vehicle ahead of the adjacent vehicle 30 relative to the own vehicle 20.

As illustrated in FIG. 2, when the speed V3 of the adjacent vehicle 30 is equal to or higher than the speed V2 of the own vehicle 20, the vehicle 20 have to accelerate to overtake the adjacent vehicle 30 when maintaining the overtaking lane 12. On the other hand, according to the driving assist system 40, when the speed V3 of the adjacent vehicle 30 is equal to or higher than the speed V2 of the own vehicle 20, it is possible for the own vehicle 20 to change its lane into the travel lane 13 and succeed the adjacent vehicle 30 by issuing an instruction to select the travel lane 13 as the lane in which the own vehicle 20 should travel via the instruction device 43. When the speed V3 of the adjacent vehicle 30 becomes low after the own vehicle 20 succeeds the adjacent vehicle 30, the same control as described above is performed, after the adjacent vehicle 30 is overtaken, based on a relative speed of a preceding vehicle relative to the own vehicle 20.

In this manner, it is advantageous to reduce potential for causing unnecessary deceleration and re-acceleration of the own vehicle 20 since the lane change of the own vehicle 20 when traveling in the overtaking lane 12 under the auto cruise mode is appropriately instructed, that is, the lane change from the overtaking lane 12 to the travel lane 13 is encouraged at an optimum timing.

The above embodiment described an example in which an instruction is issued to the driver to select one of the overtaking lane 12 and the travel lane 13 based on the relative speed ΔV1 as the lane in which the own vehicle 20 should travel. Such a selection instruction may be issued to a steering device such as a power steering (not illustrated). That is, the selection instruction from the instruction device 43 may be transmitted to the steering device as an electric signal, so that the control device 45 may perform control to maintain the overtaking lane 12 or change the lane into the travel lane 13 via the steering device.

Examples of the selection instruction can include an instruction that appeals to a visual sense by an indicator or the like, an instruction that appeals to an auditory sense such as an audio instruction or a warning sound, and an instruction that appeals to a tactile sense such as vibration.

This application is based on Japanese Patent Application (P2016-221684) filed on Nov. 14, 2016, contents of which are incorporated herein by reference.

### INDUSTRIAL APPLICABILITY

The driving assist system and the driving assist method of the present disclosure have an effect of reducing potential for causing unnecessary acceleration and deceleration when traveling on a road having two or more lanes on one side, and are useful in improving fuel efficiency.

### LIST OF REFERENCE NUMERALS

10 road

11 one side

12 overtaking lane

13 travel lane

20 own vehicle

30 adjacent vehicle

40 driving assist system

41 own vehicle speed sensor

42 adjacent vehicle speed sensor

43 instruction device

45 control device

ΔV1 relative speed

1. A driving assist system that is mounted on an own vehicle and assists a lane change of the own vehicle when the own vehicle travels on a road having two or more lanes including a travel lane and an overtaking lane on one side, the driving assist system comprising:
a relative speed acquisition device that acquires a relative speed of an adjacent vehicle relative to the own vehicle, the adjacent vehicle being traveling ahead in a same direction as the own vehicle in a lane adjacent to a lane in which the own vehicle is traveling;
an instruction device that instructs a lane in which the own vehicle should travel; and
a control device connected with the relative speed acquisition device and the instruction device,
wherein in a case where the own vehicle travels in the overtaking lane and the adjacent vehicle travels in the travel lane respectively, the control device controls the instruction device to issue an instruction to select the overtaking lane as a lane in which the own vehicle should travel when the relative speed acquired by the relative speed acquisition device is negative.

2. The driving assist system according to claim 1,
wherein the control device controls the instruction device to issue an instruction to select the travel lane as the lane in which the own vehicle should travel when the relative speed is zero or positive.

3. The driving assist system according to claim 1,
wherein in a case where the own vehicle is in constant-speed traveling in which a speed of the own vehicle falls within a constant speed range from a preset lower limit value to a preset upper limit value, the control device determines whether or not the relative speed is negative.

4. A driving assist method of assisting a lane change of an own vehicle when the own vehicle travels in an overtaking lane and an adjacent vehicle travels ahead in a travel lane in a same direction as the own vehicle respectively on a road having two or more lanes including the travel lane and the overtaking lane on one side,
wherein a control device of the own vehicle:
acquires a relative speed of the adjacent vehicle relative to the own vehicle;
determines whether or not the acquired relative speed is negative; and
controls an instruction device to issue an instruction to select the overtaking lane as a lane in which the own vehicle should travel when it is determined that the relative speed is negative.
